(19) United States
(12) Patent Application Publication
(10) Pub. No.: US 2022/0020391 A1
(43) Pub. Date: Jan. 20, 2022

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Koji SONODA, Yokohama Kanagawa (JP)

(21) Appl. No.: 17/181,949

(22) Filed: Feb. 22, 2021

(30) Foreign Application Priority Data
Jul. 15, 2020 (JP) 2020-121518

(51) Int. Cl. G11B 5/012; G11B 5/39; G11B 5/58

(52) U.S. Cl. CPC G11B 5/012; G11B 5/582; G11B 5/3967

(57) ABSTRACT

According to one embodiment, a disk device includes a housing, plurality of magnetic disks that are rotatable in the housing, magnetic heads which process data with respect to the respectively magnetic disks, a head actuator provided in the housing and supporting the magnetic heads to be movable and a capturing part formed of a material that is as easily or more easily electrostatically chargeable as or than a polycarbonate-based material in a triboelectric series, and disposed in the housing.

### CROSS-REFERENCE TO RELATED APPLICATIONS

This application is based upon and claims the benefit of priority from Japanese Patent Application No. 2020-121518, filed Jul. 15, 2020, the entire contents of which are incorporated herein by reference.

### FIELD

Embodiments described herein relate generally to a disk device.

### BACKGROUND

As a disk device, for example, a hard disk device (HDD) comprises magnetic disks disposed in a housing, a spindle motor which supports and rotates the magnetic disks, magnetic heads which carry out data processing with respect to the respective magnetic disks, a head actuator which movably supports the magnetic heads, a voice coil motor which drives the head actuator and the like.

If dust in the housing is interposed between a magnetic head and a respective magnetic disk, the dust may scratch the recording element of the magnetic head and/or the recording surface of the magnetic disk, making it difficult to carry out recording and reading. To avoid this, usually, disk drives are provided with a circulation filter installed in the flow path of air stream generated by the rotation of the magnetic disks, so as to capture the dust.

Recently, as the recording density of HDD is increased, and the spacing between a magnetic head and a respective magnetic disk is narrowed, even smaller dust may cause failure and as the countermeasure thereto, merely setting the circulation filter may be insufficient.

### BRIEF DESCRIPTION OF THE DRAWINGS

FIG. 1 is an exploded perspective view of a hard disk drive (HDD) according to an embodiment, with a top cover being exploded.

FIG. 2 is an enlarged side view schematically showing a magnetic head and a magnetic disk in the HDD.

FIG. 3 is a cross-sectional view schematically showing a ventilation filter of the HDD.

FIG. 4 is a cross-sectional view schematically showing a spoiler of the HDD.

FIG. 5 is a diagram illustrating a relationship between an applied voltage and the number of scratches created.

### DETAILED DESCRIPTION

Various embodiments will be described hereinafter with reference to the accompanying drawings. In general, according to one embodiment, a disk device comprises a housing, a magnetic disk that is rotatable in the housing, a magnetic head which processes data with respect to the magnetic disk, a head actuator provided in the housing and supporting the magnetic head to be movable, and a capturing part formed of a material that is as easily or more easily electrostatically chargeable as or than a polycarbonate-based material in a triboelectric series, and disposed in the housing.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

### First Embodiment

As a disk device, a hard disk device (HDD) according to an embodiment will be described in detail.

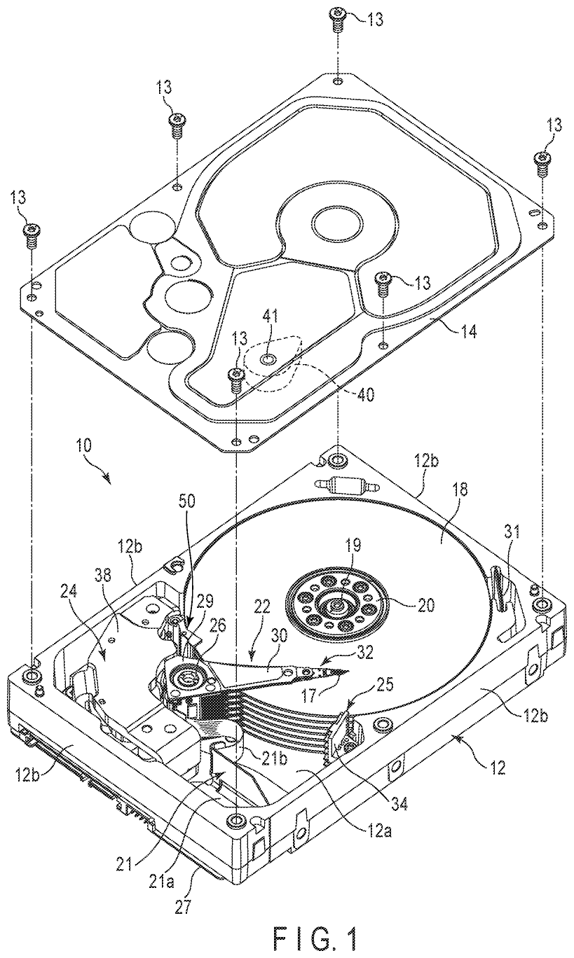

FIG. 1 is an exploded perspective view showing the HDD according to this embodiment, when a cover is removed.

The HDD comprises a flat and substantially rectangular-shaped housing 10. The housing 10 comprises a rectangular box-shaped base 12 with an upper opening, and a top cover 14. The base 12 includes a rectangular bottom wall 12a opposing the top cover 14 with a gap therebetween and side walls 12b formed to stand along edges of the bottom wall 12a, which are formed to be integrated together as one body from, for example, aluminum. The top cover 14 is formed, for example, into a rectangular plate shape from stainless steel. The top cover 14 is screwed on the side walls 12b of the base 12 with a plurality of screws 13 so as to air-tightly close the upper opening of the base 12.

In the housing 10 are provided a plurality of magnetic disks 18 as disk-shaped magnetic recording media and a spindle motor 19 which supports and rotates the magnetic disks 18. The spindle motor 19 is disposed on the bottom wall 12a. The magnetic disks 18 are each formed to have a diameter of, for example, 95 mm (3.5 inches), and include magnetic recording layers formed respectively on an upper surface and a lower surface thereof. The magnetic disks 18 are engaged coaxially each other with a hub (not shown) of the spindle motor 19, and further clamped by a clamp spring 20 so as to be fixed to the hub. Thus, the magnetic disks 18 are supported to be placed parallel to the bottom wall 12a of the base 12. The magnetic disks 18 are rotated at a predetermined number of revolutions by the spindle motor 19.

In this embodiment, as shown in FIG. 1, for example, seven magnetic disks 18 are installed in the housing 10, but the number of magnetic disks 18 is not limited to this.

In the housing 10 are provided a plurality of magnetic heads 17 for recording/reproducing data with respect to the magnetic disks 18 and a head actuator assembly 22 which supports the magnetic heads 17 to be movable with respect to the respective magnetic disks 18. The housing 10 further includes a voice coil motor (VCM) 24 which rotates and positions the head actuator assembly 22, a ramp load mechanism 25 which hold a magnetic heads 17 at an unload position spaced apart from the respective magnetic disk 18 when the magnetic heads 17 move to the outermost circumference of the magnetic disks 18, a substrate unit (FPC unit) 21 on which electronic components such as conversion connectors are mounted, and a spoiler 50.

A printed circuit board 27 is fixed by screwing to an outer surface of the bottom wall 12a of the base 12. The printed circuit board 27 constitutes a controller which controls operation of the spindle motor 19 and controls operation of the VCM 24 and the magnetic heads 17 via the substrate unit 21.

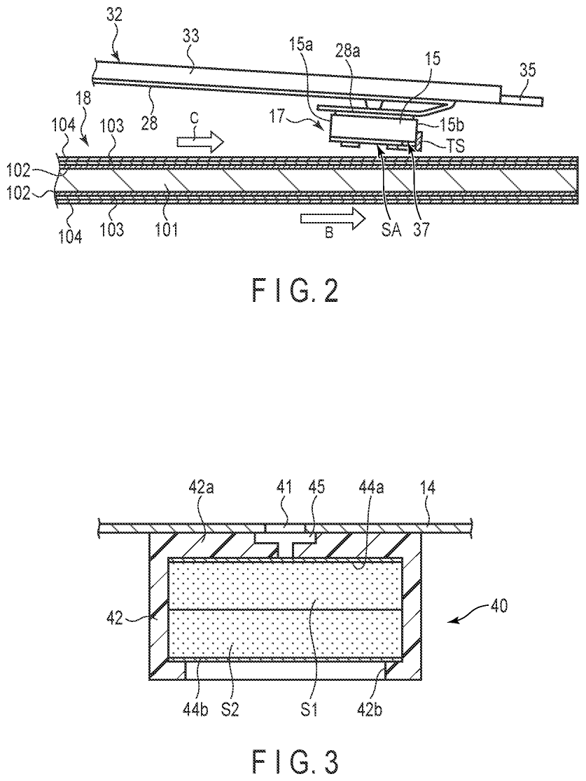

The head actuator assembly 22 comprises an actuator block 29, a plurality of, for example, eight arms 30 each extending from the actuator block 29 in the same direction, and a plurality of head gimbal assemblies (HGA) 32 provided at extending ends of the respective arms 30. The actuator block 29 is rotatably supported on a support shaft (pivot) 28 set to stand on the bottom wall 12a via a unit bearing. Each of the HGAs 32 includes a suspension (load beam) which extends from the respective arm 30, a flexure (wiring member) 28 (see FIG. 2) disposed on the load beam and the arm 30 and the respective magnetic head 17 mounted on a gimbal portion 28a of the flexure 28.

The head actuator assembly 22 further comprises a support frame (not shown) extending from the actuator block 29 in a direction opposite to that of the arm 30, and a voice coil attached to the support frame. The voice coil is located between a pair of yokes 38 disposed on the bottom wall 12a and constitutes the VCM 24 together with the yokes 38 and a magnet fixed to either one of the yokes 38.

The FPC unit 21 includes a main body 21a formed from a flexible printed circuit board, and the main the main body 21a is fixed to the bottom wall 12a of the base 12. Electronic components such as a conversion connector are mounted on the main body 21a. The conversion connector penetrates the bottom wall 12a and is connected to the printed circuit board 27. The FPC unit 21 includes a relay flexible printed circuit board (to be referred to as relay FPC hereinafter) 21b extending out from the main body 21a. An extending end portion of the relay FPC 21b is attached to a side surface (installation surface) of the actuator block 29. The extending end portion of the relay FPC 21b is electrically connected to the magnetic heads 17 via the flexure 28 described above.

The ramp load mechanism 25 comprises a ramp 34 disposed on the bottom wall 12a and located in the vicinities of the outer circumferential edges of the magnetic disks 18 and a tab 35 (see FIG. 2) provided at the distal end of each suspension. When the magnetic heads 17 move to the outermost circumference of the respective magnetic disks 18, the tab 35 of each suspension rides on the ramp 34, and the magnetic heads 17 are held at the unload position.

A circulation filter (capturing filter) 31 is provided in the housing 10 to the vicinity of a side wall 12b and located on an outer side of the magnetic disks 18. The circulation filter 31 is installed in a flow path of air stream created by rotation of the magnetic disks 18, so as to capture dust created within the housing 10 by the operation of the movable members.

According to this embodiment, the HDD further comprises a ventilation filter (desiccant) 40 provided in the housing 10. The ventilation filter 40 is fixed on an inner surface of the top cover 14 so as to oppose a ventilation hole 41 formed in the top cover 14. The ventilation filter 40 captures and removes dust and particles in the external air entering from the ventilation hole 41 into the housing 10. The ventilation filter 40 will be described in detail later.

FIG. 2 is an enlarged side view schematically showing a magnetic head and a magnetic disk of the HDD.

As shown, the magnetic disk 18 includes a substrate 101 formed into a disk shape of a nonmagnetic material. On respective surfaces of the substrate 101, a soft magnetic layer 102 as an undercoating layer, and a magnetic recording layer 103 and a protection film 104 as upper layers are stacked in the order. The magnetic disk 18 is rotated at a predetermined speed in a direction indicated by arrow B by the spindle motor 19.

Each HGA 32 comprises a suspension (load beam) 33 extending out from the respective arm 30, a flexure 28 disposed on the load beam 33 and the arm 30, and a magnetic head 17 mounted on a gimbal portion 28a of the flexure 28. A rib 35 extends from the distal end of the load beam 33.

The magnetic head 17 is configured as a flying head and comprises a substantially rectangular parallelepiped slider 15 including a flow-in end 15a and a flow-out end 15b, and a head portion 37 formed in an end portion on the flow-out-end 15b side of the slider 15. The slider 15 is formed of, for example, a sintered body of alumina and titanium carbide (AlTiC) and the head portion 37 is formed of several layers of thin films, to constitute a write element and a read element. The head portion 37 is electrically connected to a head IC and the controller (printed circuit board 27) via the wirings of the flexure 28 and the FPC unit 21.

The slider 15 comprises a substantially rectangular disk facing surface (air bearing surface: ABS) SA opposing the surface of the magnetic disk 18. The magnetic head 17 is maintained in a state where it is flying above the surface of the magnetic disk 18 by a predetermined amount by air stream C produced between the surface of the magnetic disk 18 and the disk facing surface SA by rotation of the magnetic disk 18.

In this embodiment, the magnetic heads 17 each further comprise a tactile sensor, that is, for example, a resistance detection-type thermal tactile sensor TS, provided in the slider 15. The thermal tactile sensor TS is formed of a substantially rectangular resistance element and is mounted on the flow-out end 15b of the slider 15. The thermal tactile sensor TS is electrically connected to the controller (the printed circuit board 27) via the wiring of the flexure 28 and the FPC unit 21. The thermal tactile sensor TS is turned on by the control section, so as to send a detection signal (contact signal) to the control unit. As will be discussed below, the thermal tactile sensor TS also functions as a regulator which regulates the potential difference (voltage) between a magnetic head 17 and the respective magnetic disk 18.

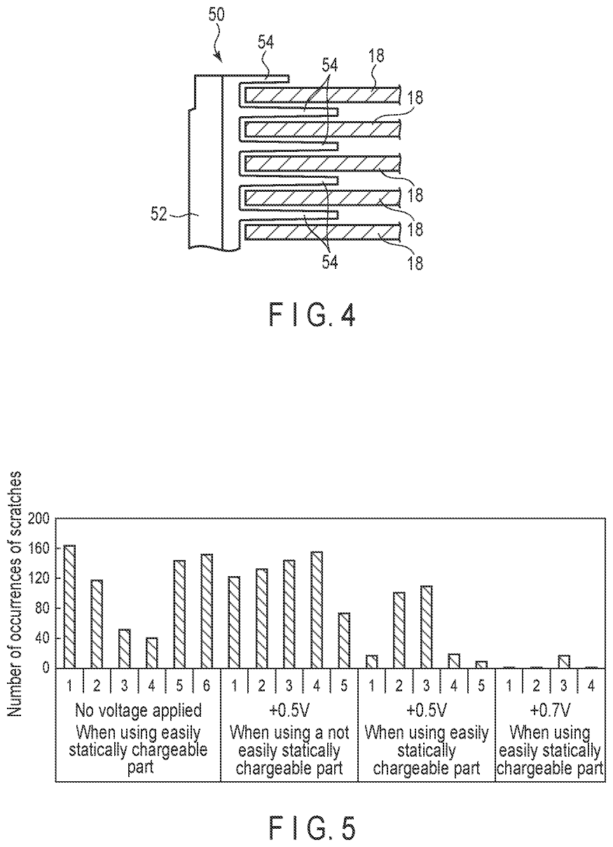

FIG. 4 is a cross-sectional view schematically showing the spoiler of the HDD.

As shown, the spoiler 50 comprises a main body 52 and a plurality of blade 54 each extending substantially perpendicular from the main body 52, which are formed to be integrated together, for example, of a synthetic resin. The blades 54 are arranged to be substantially parallel to each other at regular intervals therebetween. The spoiler 50 is placed in the vicinity of the outer circumferential edges of the magnetic disks 18 in an upstream of the head actuator assembly 22 with respect to the direction of the rotation of the magnetic disks 18. The main body 52 is set to stand substantially perpendicular on the bottom wall 12a and the blades 54 are located to oppose outer circumferential surfaces of the respective magnetic disks with gaps respectively therebetween.

FIG. 3 is a cross sectional view schematically showing the ventilation filter.

As shown, the ventilation filter 40 comprises a case 42 formed of, for example, a synthetic resin, a pair of filters 44a and 44b each formed of nonwoven fabrics and placed in the case 42 and moisture absorbents S1 and S2 of activated carbon or the like filled between the pair of filters 44a and 44b in the case 42. The case 42 comprises a top wall 42a attached on an inner surface of the top cover 14 and a lower opening 42b opposing the top wall 42a with an interval therebetween. The top wall 42a comprises an inlet 45 formed therein. The inlet 45 opposes and communicates to the ventilation hole 41 of the top cover 14. The filter 44a is disposed to block up the inlet 45, and the filter 44b is disposed to block up the lower opening 42b.

External air coming in through the inlet 45 from the ventilation hole 41 flows into the housing 10 via the filter 44a, the absorbents S1 and S2 and the filter 44b. The ventilation filter 40 captures dust in the external air by the filters 44a and 44b and also absorbs the moisture in the external air by the absorbents S1 and S2.

The HDD comprises a capturing part disposed near the magnetic disks 18 in the housing 10, so as to capture dust in the housing. In this embodiment, the ventilation filter 40 is employed as the capturing part.

More specifically, the case 42 of the ventilation filter 40 is formed of a material that is as easily or more easily electrostatically chargeable as or than the polycarbonate-based materials in the triboelectric series, preferably, a material which is easily negatively chargeable, that is, for example, polycarbonate. A frictional electrification occurs between the case 42 formed of polycarbonate and the air stream created by rotation of the magnetic disk 18, and the case 42 is charged negative. Consequently, the dust attached to or coming close to the case 42 is charged to a reverse polarity, positive, and it is adsorbed on the surface of the case 42 so as to be captured. Thus, the dust in the housing 10 can be reduced, thereby making it possible to inhibit the failure which may be caused by the dust.

Note that usable example of the material which is as easily or more easily statically chargeable as or than the polycarbonate-based material in the triboelectric series are, besides polycarbonate, synthetic resins such as Teflon (registered trademark), vinyl chloride, polyethylene, acryl and the like.

Here, when some kind of impact is applied to the HDD, there may be some possible cases where dust attached to the case 42 falls off from the case 42. In this embodiment, the HDD comprises a regulator to adjust a potential difference between a magnetic head 17 and a respective magnetic disk 18 in order for the magnetic head 17 side to be charged positive, which is the same polarity as that of the dust, so that the dust does not attach to the magnetic head 17 even if the dust falls off. In this embodiment, the thermal tactile sensor (resistance element) TS provided on the magnetic head 17 is used as the regulator. When voltage is applied to the thermal tactile sensor TS from the control unit (the printed circuit board 27), the potential of the magnetic head 17 can be changed by about ±1 V.

It is preferable that the potential of the magnetic head 17 be set higher than or equal to 0.5 V.

FIG. 5 is a diagram showing results of measurements of the relationship between the potential of a magnetic head and the number of occurrences of scratches (flaws) made on the magnetic disk 18 when a predetermined amount of particle is introduced to the housing while the magnetic disks are rotated, in the cases where the case 42 formed of a material which is easily statically chargeable (for example, polycarbonate) and where a case formed of a material which is not easily statically chargeable.

As can be understood from the diagram, when voltage is not applied to the magnetic head, there are a number of occurrences of scratches. In the case where the material which is not easily statically chargeable is used, the number of occurrences of scratches is not reduced if the potential of the magnetic head is set to +0.5 V. When using an easily statically chargeable material is used, a clear difference appears at a voltage supplied to the magnetic head of +0.5 V or higher, and the number of occurrences of scratches decreases as the supplied voltage is higher. But in consideration of the influence on the consumption power and the spacing between the magnetic head and the magnetic disk, the voltage should preferably be +1 V or less. Therefore, it is preferable that the potential of the magnetic head 17 be set to 0.5 V or higher but 1 V or less.

By applying the above-indicated voltage to the magnetic head 17, it is possible to inhibit the dust attaching to the magnetic head 17 and thus the scratching on the magnetic disk can be prevented. That is, the failure which may be caused by the dust can be inhibited.

Note that the regulator which adjusts the voltage of the magnetic head 17 is not limited to a thermal tactile sensor, but some other arbitrary adjusting means may be used.

According to the HDD of this embodiment configured as described above, the capturing part formed of an easily statically chargeable material is provided in the vicinities of the magnetic disks 18 in the housing. With this structure, the dust created in the housing is captured by the capturing part, thereby making it possible inhibit the failure which may be caused by the dust. Further, even if the dust is detached from the capturing part and moves into the housing, it is possible to prevent dust from locating between a magnetic head and a respective magnetic disk by applying voltage of a polarity reverse to that of the dust, to the magnetic head. Thus, the malfunction of the magnetic head and the magnetic disk, which may be caused by dust, can be inhibited. Thus, the failure which may be caused by the dust is suppressed, and a magnetic disk device with improved reliability can be provided.

According to this embodiment, the capturing part is formed of a material of synthetic resin which is easily statically chargeable to be negative. With this configuration, the amount of electrostatic charge is increased, and a higher dust removal effect can be expected. Further, by appropriately setting a potential to be applied to the magnetic head, the dust removal effect is enhanced, thereby making it possible to provide a highly reliable magnetic disk unit.

According to this embodiment, a conventional ventilation filter is used as the capturing part, and thus a dust removal effect can be obtained without adding a structural component, thereby making it possible to reduce the production cost.

Next, a capturing part according to another embodiment will be described. In the other embodiments to be described below, portions equivalent to those of the first embodiment are denoted by the same reference numbers and detailed explanation thereof is omitted, and such explanation will be mainly given to portions different from those of the first embodiment.

### Second Embodiment

In a second embodiment, the HDD shown in FIG. 1 comprises a spoiler 50 as the capturing part in place of the ventilation filter 40. More specifically, the spoiler 50 is formed of a material that is as easily or more easily electrostatically chargeable as or than the polycarbonate-based materials in the triboelectric series, preferably, a material which is easily negatively chargeable with static electricity, that is, for example, polycarbonate. A frictional electrification occurs between the air stream created by rotation of the magnetic disks 18 and the spoiler 50, and the spoiler 50 is charged negative. Consequently, the dust attached to or coming close to the spoiler 50 is charged to a reverse polarity, positive, and it is adsorbed on the surface of the spoiler 50 so as to be captured.

### Third Embodiment

In a third embodiment, the HDD shown in FIG. 1 comprises a ramp 34 as the capturing part in place of the ventilation filter 40. More specifically, the ramp 34 is formed of a material that is as easily or more easily electrostatically chargeable as or than the polycarbonate-based materials in the triboelectric series, preferably, a material which is easily negatively chargeable, that is, for example, polycarbonate. A frictional electrification occurs between the air stream created by rotation of the magnetic disks 18 and the ramp 34, and the ramp 34 is charged negative. Consequently, the dust attached to or coming close to ramp 34 is charged to a reverse polarity, positive, and it is adsorbed on the surface of the ramp 34 so as to be captured.

In the second and third embodiments discussed above, the other configuration of the HDD is the same as that of the HDD of the first embodiment. With the second and third embodiments as well, advantageous operational effects similar to those of the first embodiment can be obtained.

Note that the number of capturing parts may be two or more instead of only one. For example, two or all of the ventilation filter, spoiler and ramp may be configured as capturing parts. The capturing parts are not limited to the existing parts, but an independent capturing part may be installed in the housing. It is preferable that the capturing part(s) should be installed in a section(s) where the stream of flow is fast in the housing.

While certain embodiments and modifications have been described, these embodiments and modifications have been presented by way of example only, and are not intended to limit the scope of the inventions. Indeed, the novel embodiments and modifications described herein may be embodied in a variety of other forms; furthermore, various omissions, substitutions and changes in the form of the embodiments and modifications described herein may be made without departing from the spirit of the inventions. The accompanying claims and their equivalents are intended to cover such forms or modifications as would fall within the scope and spirit of the inventions.

For example, the capturing parts may be applied not only to the ventilation filter, spoiler and ramp, but also to other parts made of synthetic resin and located in the vicinities of the magnetic disks. In the HDD, the number of magnetic disks installed is not limited to seven, but six or less, or eight or more. Here, the number of HGAs and the number of magnetic heads are increased or decreased in accordance with number of magnetic disks installed.

What is claimed is:

1. A disk device comprising:
a housing;
a magnetic disk that is rotatable in the housing;
a magnetic head which processes data with respect to the magnetic disk;
a head actuator provided in the housing and supporting the magnetic head to be movable; and
a capturing part formed of a material that is as easily or more easily electrostatically chargeable as or than a polycarbonate-based material in a triboelectric series, and disposed in the housing.

2. The disk device of claim 1, further comprising:
a regulator which applies a voltage of a reversed polarity to that of the capturing part to between the magnetic head and the magnetic disk.

3. The disk device of claim 2, wherein
a voltage applied to the magnetic head is 0.5 V or higher but 1 V or less.

4. The disk device of claim 1, wherein the capturing part is arranged in a position contactable with an air stream to occur by rotation of the magnetic disk.

5. The disk device of claim 1, wherein the capturing part is a filter comprising a case formed of the material and a moisture absorbent accommodated in the case.

6. The disk device of claim 1, wherein the capturing part is a spoiler formed of the material and disposed in a vicinity of an outer circumference of the magnetic disk.

7. The disk device of claim 1, wherein
the capturing part is a ramp formed of the material and disposed in a vicinity of an outer circumference of the magnetic disk.

8. The disk device of claim 1, wherein
the material is a synthetic resin which is easily negatively charged electrostatically, which contains any one of polycarbonate, Teflon, vinyl chloride, polyethylene and acryl.
